(19) United States
(12) Patent Application Publication
(10) Pub. No.: US 2013/0166654 A1
(43) Pub. Date: Jun. 27, 2013

(54) Method and Arrangement in a Peer-to-Peer Network

(71) Applicants: Johan Hjelm, Tokyo (JP); Mattias Lidstrom, Stockholm (SE); Mona Matti, Nacka (SE)

(72) Inventors: Johan Hjelm, Tokyo (JP); Mattias Lidstrom, Stockholm (SE); Mona Matti, Nacka (SE)

(73) Assignee: Telefonaktiebolaget L M Ericsson (publ), Stockholm (SE)

(21) Appl. No.: 13/819,436

(22) PCT Filed: Aug. 31, 2010
(86) PCT No.: PCT/SE10/50926

§ 371 Date: Feb. 27, 2013

(51) Int. Cl. H04L 29/08

(52) U.S. Cl. CPC H04L 67/104
USPC 709/204

(57) ABSTRACT

A method and arrangment for enrolling a joining peer (202) to a P2P (peer-to-peer) to the P2P network receives (2:2) a connect request sent from the joining peer, and obtains (2:4-2:7) an enrollment recommendation for the joining peer at least based on a stored current topology (208) of the P2P network. The enrollment a server then sends (2:9) attach information to the joining peer according to the enrollment recommendation. The attach information indicates where the joining peer shall connect to the P2P network. The enrollment server also updates (2:13) and stored toplogy of the P2P network when the joining peer has connected to the P2P network.

### TECHNICAL FIELD

The invention relates generally to a method and arrangement for enrolling a joining peer to a peer-to-peer network.

### BACKGROUND

Various services have been developed involving packet-based communication using IP (Internet Protocol), typically involving transmission of media and messages between communication nodes such as fixed or mobile telephones, computers and sewers. For example, a media session according to a requested IP service is typically established for a user terminal, acting as “client”, by means of an application or service node, acting as “server”. The application or service function may be implemented in a central service node or application sewer, e.g. belonging to an IMS (IP Multimedia Subsystem) network.

IP communication sessions can also be established and handled solely by user terminals without involving any intermediate central service node, thus forming a peer-to-peer (P2P) network with participating peers, e.g. for sharing processing and/or storing resources with the purpose of performing a certain task or function. Some examples of P2P networks are distributed databases, calculation and processing of data, any so-called “cloud services”, delivery of distributed media content such as films or music, electronic games, distributed search engines, and so forth. This type of “virtual” network is sometimes referred to as an “overlay P2P network” and can be formed on a more or less temporary basis involving any selection of peers, such as the nodes exemplified above, being connected to various networks for IP communication.

Basically, a P2P network does not distinguish between clients or sewers but comprise only equal peer nodes that simultaneously can act as both clients and sewers. This model of network arrangement thus differs from the client-sewer model above where the communication is controlled by some central sewer. In a P2P session, media and messages are transmitted in data packets directly between the peers and the data packets are routed through an IP network, e.g. the Internet, over various routers having their own mechanisms for handling different data flows. However, the routers are typically not concerned with what media or messages the packets contain and can be considered transparent in this context, and the peers must therefore negotiate and agree on various communication parameters depending on their capabilities.

P2P applications on the Internet are becoming increasingly popular, e.g. for utilising resources in multiple nodes and for downloading content such as music and films. In the leather case, a technique referred to as “Bit Torrent” is a very powerful distribution mechanism that can be used for rapid sharing of content and computer programs over the Internet without requiring a traditional centralized content sewer. After obtaining a list of peers of a content distributed P2P network, an outside client can download different parts of some requested content simultaneously from the peers in the list and form the complete content therefrom for playout. Furthermore, so-called Distributed Hash Tables, DHTs, are typically used for identifying the peers for downloading.

In an overlay P2P network, the participating peers are connected to one another according to a certain network topology and may have differentiated capabilities that can be utilised in one way or another for contributing to the general function or task to be performed by the P2P network. For example, one peer may have a very powerful processor while another peer may have great storage capacity. FIG. 1 illustrates an example of how the topology of an overlay P2P network 100 might be configured, where a plurality of peers P1-P7 are connected according to a specific pattern. One peer P6 may be assigned to work as a point of contact for outside terminals 102 for receiving service requests or queries, e.g. directed to a particular URL(Universal Resource locator) address associated to peer P6.

During the lifetime of P2P network 100, peers may join or leave the network such that the overall topology is changed. Adding a joining peer to the P2P network can be referred to as “enrollment” of the peer. In FIG. 1, a new peer P8 is enrolled as it connects to one of the existing peers P7. As a result, peer P8 will be connected to P7 in the new topology as illustrated. However, it is a drawback that this position in the network may be less than optimal and even impractical when considering the capabilities and current status of peer P8 in relation to what is wanted or needed from the new peer P8 to functionally contribute to the P2P network 100.

DHTs may be used in a P2P network for publication and discovery of different resources therein, i.e. capabilities and content in the participating peers. The existing store and lookup functions of the DHT mechanism may thus be used for discovery. The peers can also be allocated keywords representing its resources, which implies that the keywords of available resources must be distributed among the peers in the network such that each peer stores a distributed index of keywords. For example, the existing overlay algorithm called “Chord” requires that each peer has a so-called “finger” table and a neighbor table with such resource keywords.

It is therefore another drawback that the tables and indices must be updated in all peers whenever the network topology is changed, i.e. when peers join or leave the overlay network. Yet another drawback when a peer is enrolled to a certain spot and a certain role in an overlay P2P network according to current known procedures, is that its position and role in the topology may not be very suitable with respect to its current situation, status, resources and/or capabilities. It is also difficult to employ load balancing amongst the peers for handling incoming requests.

### SUMMARY

It is an object of the invention to address at least some of the problems and issues outlined above. It is also an object to provide a useful mechanism for enrolling a peer to an existing P2P network in an appropriate manner, e.g. to a proper position and/or role in the network. It is possible to achieve these objects and others by using a method and an arrangement as defined in the attached independent claims.

According to one aspect, a method is provided for enrolling a joining peer to a P2P network, to be executed by an enrollment server associated to the P2P network. In this method, the enrollment server receives a connect request sent from the joining peer, and obtains an enrollment recommendation for the joining peer at least based on a stored current topology of the P2P network. The enrollment server then sends attach information to the joining peer according to the enrollment recommendation in response to the connect request, the attach information basically indicating where the joining peer shall connect to the P2P network. If the enrollment is completed, the enrollment server updates the stored topology of the P2P network when the joining peer has connected to the P2P network.

According to another aspect, an arrangement is provided in an enrollment server configured to enroll a joining peer to a P2P network by means of functional modules. According to this arrangement, the enrollment server comprises a communication module adapted to receive a connect request sent from the joining peer, and an obtaining module adapted to obtain an enrollment recommendation for the joining peer at least based on a stored current topology of the P2P network. The enrollment server also comprises an updating module adapted to update the stored topology of the P2P network when the joining peer has connected to the P2P network. The communication module is further adapted to send attach information to the joining peer according to the enrollment recommendation in response to the connect request, the attach information indicating how the joining peer shall connect to the P2P network.

The above method and arrangement may be configured and implemented according to different embodiments. In some possible embodiments, the enrollment recommendation is further based on qualifications of the joining peer including at least one of current contact, capabilities and current status of the joining peer. The enrollment recommendation may be further based on at least one of current roles and/or qualifications of other peers in the P2P network, load balancing, connection costs, latency, and enrollment history and social network information regarding the joining peer.

In further possible embodiments, the enrollment recommendation may indicate one or more admitting peers to which the joining peer shall be connected in the P2P network, and may also indicate a bootstrap peer in the P2P network which handles an attach procedure for the joining peer when connecting to the admitting peer(s) by relaying attach messages. The enrollment recommendation may further indicate a role the joining peer shall have in the P2P network, the role involving one or more processing and/or storing tasks. In that case, the enrollment server further sends configuration information to the joining peer indicating that role. The enrollment recommendation may also indicate one or more index keywords to be assigned to the joining peer for use in service requests or queries to the P2P network from outside parties.

The enrollment server may also at some point receive a leave request from a peer in the P2P network, indicating that this peer is leaving the P2P network, and the enrollment server then updates the stored topology of the P2P network accordingly.

Further possible features and benefits of this solution will become apparent from the detailed description below.

### BRIEF DESCRIPTION OF DRAWINGS

The invention will now be described in more detail by means of exemplary embodiments and with reference to the accompanying drawings, in which

FIG. 1 is a block diagram illustrating a typical example P2P network, according to the prior art.

FIG. 2 is a block diagram illustrating a procedure and arrangement for enrolling a joining peer to a P2P network, according to an example embodiment

FIG. 3 is a flow chart with actions performed by an enrollment server for enrolling a joining peer, according to further example embodiments.

FIG. 4 is a block diagram illustrating in more detail a arrangement in an enrollment server, according to another example embodiment

FIG. 5 is a signalling diagram illustrating a practical example of how a joining peer can be enrolled to a P2P network, according to further possible embodiments.

### DETAILED DESCRIPTION

Briefly described, a solution is provided to obtain a fitting enrollment of a joining peer to a P2P network, e.g. in terms of position, function and role of the joining peer in the P2P network. This can be accomplished by employing an enrollment function implemented in an enrollment server associated to the P2P network, e.g. as implemented in one of the peers therein. The enrollment server obtains an enrollment recommendation for the joining peer at least based on the current topology of the network and optionally also based on certain qualifications of the joining peer. For example, these qualifications may relate to the current context, capabilities and/or current status of the joining peer. The enrollment recommendation may be created by means of a recommender service which could be implemented either in the same node as the enrollment server itself or in another node in the P2P network.

The obtained enrollment recommendation may refer to a suitable or fitting network position for the joining peer, i.e. specifying one or more peers in the P2P network the joining peer shall be connected to, in the following description also referred to as “admitting” peer(s). The enrollment recommendation may also refer to a specific role or function the joining peer shall have in the network, i.e. which task(s) or operation(s) are required to be performed in order to contribute to the overall function of the P2P network in a fitting or even optimal manner. For example, the joining peer may be appointed to store a certain type and/or amount of data if the P2P network has the overall function of a distributed database. The role may thus involve one or more storing and/or processing tasks.

The enrollment recommendation may further refer to a so-called “bootstrap peel” in the P2P network which handles the attach procedure for the joining peer when connecting to the admitting peer(s). The bootstrap peer may be the enrollment server itself or another peer node in the P2P network. The enrollment server sends attach information to the joining peer according to the enrollment recommendation, indicating where the joining peer shall connect to the P2P network. The enrollment server may further send configuration information to the joining peer indicating its future role in the P2P network.

Once the joining peer has connected to one or more admitting peers and has thus joined the P2P network according to the enrollment recommendation and sent attach information, the enrollment peer updates the current topology and configuration of the P2P network accordingly, which may be maintained in a database or the like e.g. implemented in one of the network's peers or in an external node.

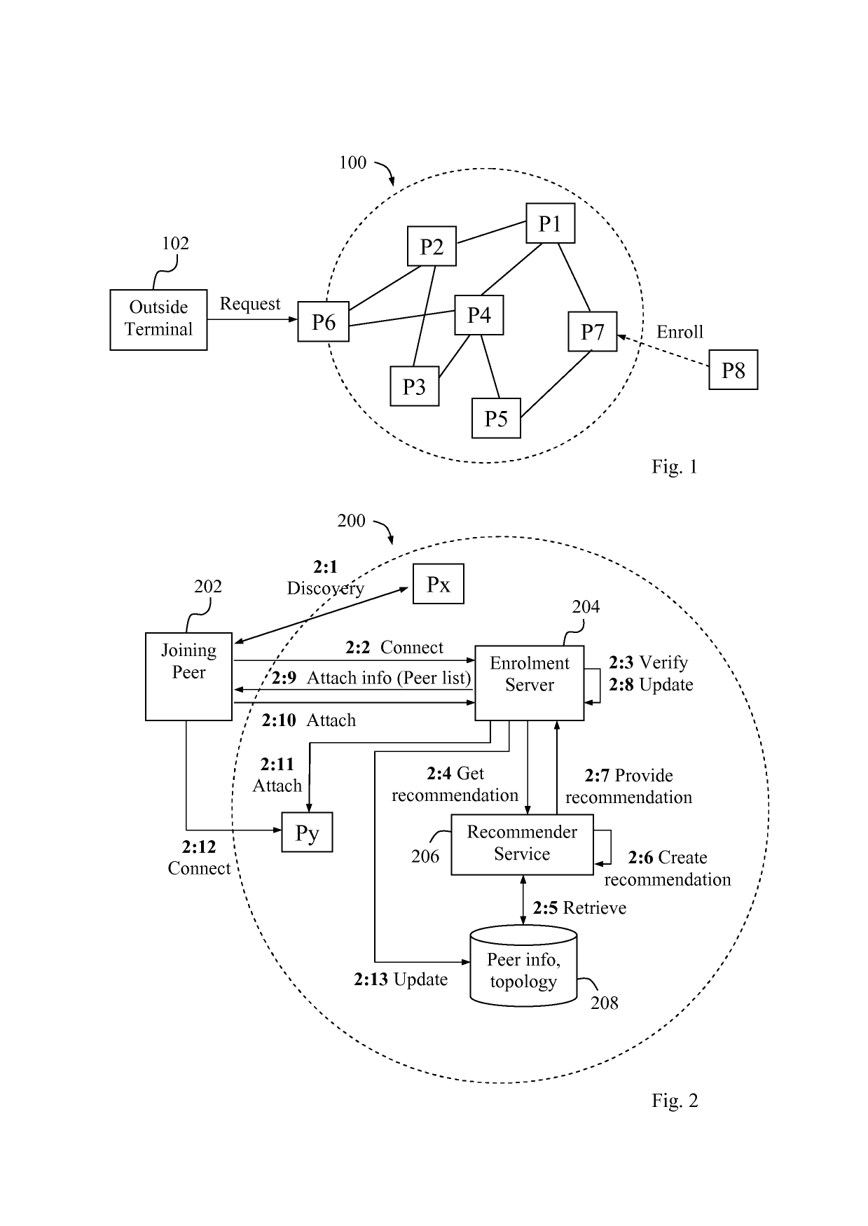

An example of how a joining peer can be enrolled to a P2P network in accordance with this solution, will now be described with reference to FIG. 2. It is assumed that the schematically shown P2P network 200 involves a plurality of peers connected to one another according to a certain network topology, not shown here but the topology may be similar to that shown in FIG. 1, without limitation thereto. It is also assumed that the P2P network 200 has been formed in order to fulfill some function or task requiring various resources in the peers which may have differentiated capabilities and contribute in different or equal ways to the general function or task, as in the network of FIG. 1.

An outside peer 202 will now join the network 200, which can be accomplished in a fitting manner as follows, the peer 202 being hereafter accordingly referred to as a joining peer. A first action 2:1 illustrates that the joining peer 202 initially contact one of the peers in the network, denoted “Px”, and performs a regular discovery process with peer Px. The peer Px may act as a point of contact for outside parties to the P2P network 200, e.g. for receiving service requests and queries directed to a public URLaddress of Px, or may in another way be known to peer 202. In the discovery process, peer Px directs the joining peer 202 to contact an enrollment server 204 to proceed with the enrollment to network 200. The enrollment server 204 may be implemented in one of the peers of the P2P network 200 which may or may not be the same peer as the one Px acting as a point of contact for external parties.

In a next action 2:2, the joining peer 202 accordingly sends a connect request to enrollment server 204. The connect request is effectively a request for joining the P2P network 200 in order to contribute to its function or task with new resources in a suitable manner. Without limitation, the function or purpose of P2P network 200 could be anything that can be realized with such a network, which was exemplified in the background section above, and the invention is thus not limited in this respect The invention is neither limited to any particular resources in the joining peer 202 that will be utilised once it has joined the network 200. As mentioned above, such resources may be related to one or more of processing and storing capabilities as well as stored content or data and installed applications in the peer 202.

In this action, the joining peer 202 also sends information on its available resources and may also send information on its current context and/or terminal status to the enrollment server 204. The context may relate to geographic position, physical environment and characteristics of the peer's current access network, e.g. in terms of traffic class, available bandwidth and latency. The terminal status may relate to a current mode of operation, any activated call forwarding,

After receiving the connect request from peer 202, the enrollment server 204 checks basically if the peer is authorised to join the P2P network 200, in a following action 2:3, e.g. by means of an internal process or by contacting some external credential server or the like, not shown, that can verify the peer 202 by authentication based on credentials stored for the peer. The verification procedure itself is somewhat outside the scope of this solution and is not necessary to describe here to understand the invention

The enrollment server 204 then generally obtains an enrollment recommendation for the joining peer 202, in this example by triggering the recommendation from a recommender service 206 in an action 2:4. In practice, the recommender service 206 may be implemented in the same node or peer as the enrollment server 204, or in any other node or peer of the network 200, while it is schematically shown as a separate functional unit in FIG. 2. It is assumed that the above information on resources and current context and/or status of peer 202, if received therefrom, is made available to the recommender service 206.

The recommender service 206 retrieves information on the current topology of the P2P network 200, in a further action 2:5, which is maintained in a database 208 associated to the network 200. The network topology thus basically refers to how the peers in network 200 are connected to one another. The recommender service 206 may also retrieve, from database 208, information on the other peers in the P2P network, such as their current roles in the network and/or qualifications, which together with the network topology accordingly make up the configuration of P2P network 200.

In a next action 2:6, recommender service 206 creates an enrollment recommendation for the joining peer 202, at least based on the retrieved topology information and optionally also based on qualifications of the joining peer including at least one of its current context, capabilities and current status. The creation of the enrollment recommendation may be further based on at least one of current roles and/or qualifications of other peers in the P2P network 200, load balancing, connection costs, latency, enrollment history and social network information regarding the joining peer.

The current roles and/or qualifications of other peers may be extracted from the information retrieved in action 2:5 above. The load balancing aspect refers to the distribution or allocation of tasks among the peers to even out their load and/or to utilise their resources in an effective or even optimal manner. The connection costs refer to access and transport costs for communicating data and messages to/from the individual peers in the network 200, and the total connection costs for the network should naturally be kept low. The latency refers to any resulting delays when communicating data and messages to/from the individual peers which may be important for certain services. The enrollment history refers to any previous enrollment(s) of the peer 202 to network 200 or to other P2P networks and which role it had then, and any previous recommendations made for peer 202 can be used as input data. The social network information mainly refers to the physical or topological closeness, i.e. proximity, of the joining peer to other peers in the network. A social graph may be maintained in database 208 representing such information.

According to different possible options, the created enrollment recommendation may indicate a position the joining peer shall have in the P2P network, i.e. one or more other peer(s) to which it shall be directly connected in the P2P network, in the following referred to as “admitting peers”, implying a new topology. The enrollment recommendation may further indicate a role the joining peer shall have in the P2P network, e.g. involving one or more processing and/or storing tasks.

In order to create a fitting enrollment recommendation for the joining peer 202, different candidate network positions and roles for the joining peer 202 may be tried out, e.g. by calculating the performance of the resulting network topology and configuration for each candidate position/role in terms of efficiency, costs and load distribution. The recommendation may also comprise multiple alternatives of network positions and roles for the joining peer 202 with different resulting levels of performance, as calculated.

In FIG. 2, recommender service 206 basically provides the created enrollment recommendation to the enrollment server 204, in a further action 2:7, e.g. indicating the most efficient network position connecting to one or more admitting peers and a suitable role for the joining peer 202, or multiple alternative positions/roles as described above. The enrollment server 204 then updates the configuration of network 200 with the new peer 202, that is, according to the enrollment recommendation or a selected alternative thereof, in a following action 2:8.

As in prior P2P networks discussed above, the configuration of network 200 may be neatly defined by means of one or more index keywords assigned to each peer in the network 200, indicating available resources and/or other characteristics of the respective peers. The index keywords may be organized in any manner, e.g. in multiple hierarchical levels of a tree structure, and can be used in service requests or queries to the P2P network from outside parties. In this invention, it is a great advantage that it is not necessary to maintain updated indices of keywords in the individual peers as they can be more efficiently maintained by the enrollment server 204 instead. Thus, there is no need to distribute such indices of keywords amongst the peers, thereby saving much processing and communication costs.

If such index keywords are employed in the P2P network 200, the enrollment recommendation in the above actions 2:6, 2:7 may further indicate one or more index keywords to be assigned to the joining peer 202, and the enrollment server 204 updates the configuration of network 200 with the new index keyword(s) of peer 202 in action 2:8.

In a next action 2:9, the enrollment server 204 sends so-called “attach information” to the joining peer 202 according to the enrollment recommendation in response to the connect request The attach information basically indicates where the joining peer shall connect to the P2P network, e.g. identifying the one or more admitting peers to which the joining peer 202 shall be connected in the P2P network, which could be indicated in a peer list Alternatively or additionally, the attach information may indicate one or more bootstrap peers in the P2P network assigned to handle an attach procedure for any joining peer when connecting to the admitting peer(s), by relaying attach messages between the joining peer and the admitting peer(s). In this example, one admitting peer “Py” is shown further, the enrollment server 204 will act as a bootstrap peer in this example and will thus handle the attach procedure for peer 202.

Unless the user of peer 202 decides to refrain from joining network 200 at this point, the joining peer 202 performs a regular attach dialogue with the assigned bootstrap peer, i.e. enrollment server 204, in a following action 2:10, typically involving an attach request from peer 202 and an attach response from server 204. This attach procedure may be executed automatically without requiring any manual actions from the user. A further action 2:11 illustrates that enrollment server 204 relays the attach dialogue to the admitting peer Py finally, after the attach procedure has been completed, the joining peer connects directly to the admitting peer Py in an action 2:12, and the bootstrap peer/enrollment server 204 accordingly updates the network topology and configuration maintained in database 208, in a last shown action 2:13. It should be noted that the joining peer may in this way connect to more than one admitting peer, and the above attach procedure of actions 2:10-2:12 may in that case be valid for each admitting peer.

In this way, the enrollment server 204 and the recommender service 206 can provide a suitable and fitting, if not optimal, position and role for the joining peer 202 by taking at least the current network topology and optionally also qualifications of the joining peer and of the other peers into consideration for example, a fitting position and role to be recommended for the joining peer 202 can be calculated in view of optimizing the overall network performance, as described above.

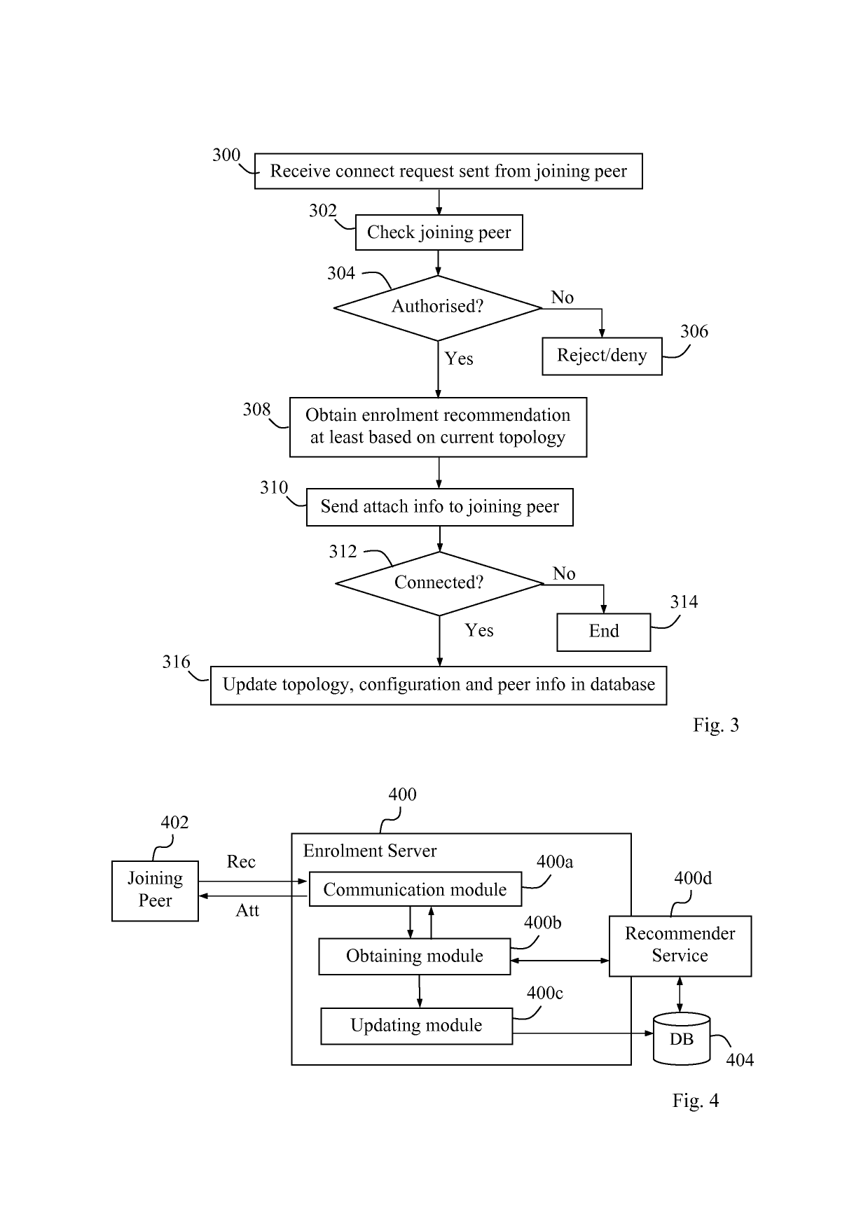

A procedure will now be described, with reference to the flow charting FIG. 3, of enrolling a joining peer to a P2P network, which involves different actions executed by an enrollment server associated to the P2P network. This procedure may thus basically be realised by means of the enrollment server 204 and the recommender service 206 of FIG. 2. The P2P network may be an already existing network, or the procedure below may be part of forming the network.

In a first action 300, the enrollment server receives a connect request sent from the joining peer, basically corresponding to action 2:2 above, which preferably also contains information on the peer such as its qualifications and/or context The enrollment server then checks credentials or the like of the joining peer to see if the peer is authorised to join the P2P network 200, in a following action 302, basically corresponding to action 2:3 above. A next determining action 304 illustrates that if the joining peer is not authorised, the connect request is rejected and the peer is denied to join in an action 306, while if the peer is authorised the enrollment server obtains an enrollment recommendation for the joining peer in an alternative action 308. The enrollment recommendation can be created by using information on the network topology and optionally also on network peers, the information being maintained in a database such as the database 208 of FIG. 2.

As described in the example of FIG. 2, the enrollment recommendation is at leastbased on the P2P network topology and optionally also based on qualifications of the joining peer. The enrollment recommendation may be further based on any of current roles and/or qualifications of other peers in the P2P network, load balancing, connection costs, latency, enrollment history and social network information regarding the joining peer. The peer qualifications above basically indicate how each peer can work and contribute to the P2P network, and could suitably include at least one of current context, capabilities and current status of the respective peers. Action 308 of obtaining the enrollment recommendation basically corresponds to actions 2:4 2:7 above.

In a further action 310, the enrollment server sends attach information to the joining peer according to the enrollment recommendation and in response to the connect request The attach information thus indicates basically where/how the joining peer shall connect to the P2P network, and may include the address of one or more admitting peers or one or more bootstrap peers, as explained above for action 2:9. The next action 312 illustrates determination of whether the joining peer has actually joined the P2P network and is thus connected thereto. If not the process may simply end in an action 314. Otherwise, the network topology and configuration has accordingly changed by addition of the joining peer as dictated by the enrollment recommendation, and a final action 316 illustrates that the enrollment server updates the information on the topology and participating peers maintained in the database, basically corresponding to action 2:13 above.

With reference to the block diagram in FIG. 4, an arrangement in an enrollment server 400 of a P2P network, configured to enroll a joining peer 402 to the P2P network, will now be described. This arrangement may be implemented as an application in the enrollment server. The enrollment server 400 can be configured to basically operate according to any of the examples described above for FIGS. 2 and 3, whenever appropriate. According to this arrangement, the enrollment server 400 comprises a communication module 400a adapted to receive a connect request“Req” sent from the joining peer.

Enrolment server 400 also comprises an obtaining module 400b adapted to obtain an enrollment recommendation for the joining peer 402 at least based on a current topology of the P2P network being stored in a database 404. Enrolment server 400 also comprises an updating module 400c adapted to update the stored topology of the P2P network when the joining peer 402 has connected to the P2P network. The communication module 400a is further adapted to send attach information “Ate' to the joining peer according to the enrollment recommendation in response to the connect request, the attach information indicating how the joining peer shall connect to the P2P network.

The different modules in the enrollment server 400 may be configured and adapted to provide further optional features and embodiments. In one example embodiment, the enrollment server 400 also comprises a recommender service 400d adapted to create the enrollment recommendation, e.g. in the manner described above for actions 2:5, 2:6 and 308, respectively.

In further possible embodiments, the created enrollment recommendation obtained by module 400b can be further based on qualifications of the joining peer 402 including at least one of current context, capabilities and current status of the joining peer. The enrollment recommendation can be further based on at least one of current roles and/or qualifications of other peers in the P2P network, load balancing, connection costs, latency, enrollment history and social network information regarding the joining peer 402.

In more detail according to further embodiment, the attach information Att may indicate a bootstrap peer in the P2P network which handles the attach procedure for the joining peer 402 when connecting to the admitting peer(s) by relaying attach messages. As in the above examples, the enrollment server 400 may also act as the bootstrap peer. The enrollment recommendation may indicate one or more admitting peers to which the joining peer shall be connected in the P2P network, and also which role the joining peer shall have in the P2P network in terms of one or more processing and/or storing tasks. The communication module 400a may thus be further adapted to send configuration information to the joining peer indicating that role.

The enrollment recommendation may further indicate one or more index keywords to be assigned to the joining peer, which keywords can be used in any service requests or queries to the P2P network made from outside parties. The enrollment server could also, at some point during the lifetime of the P2P network, receive a leave request from a peer in the P2P network, indicating that this peer is leaving the P2P network, i.e. disconnecting therefrom, and updates the stored topology of the P2P network accordingly.

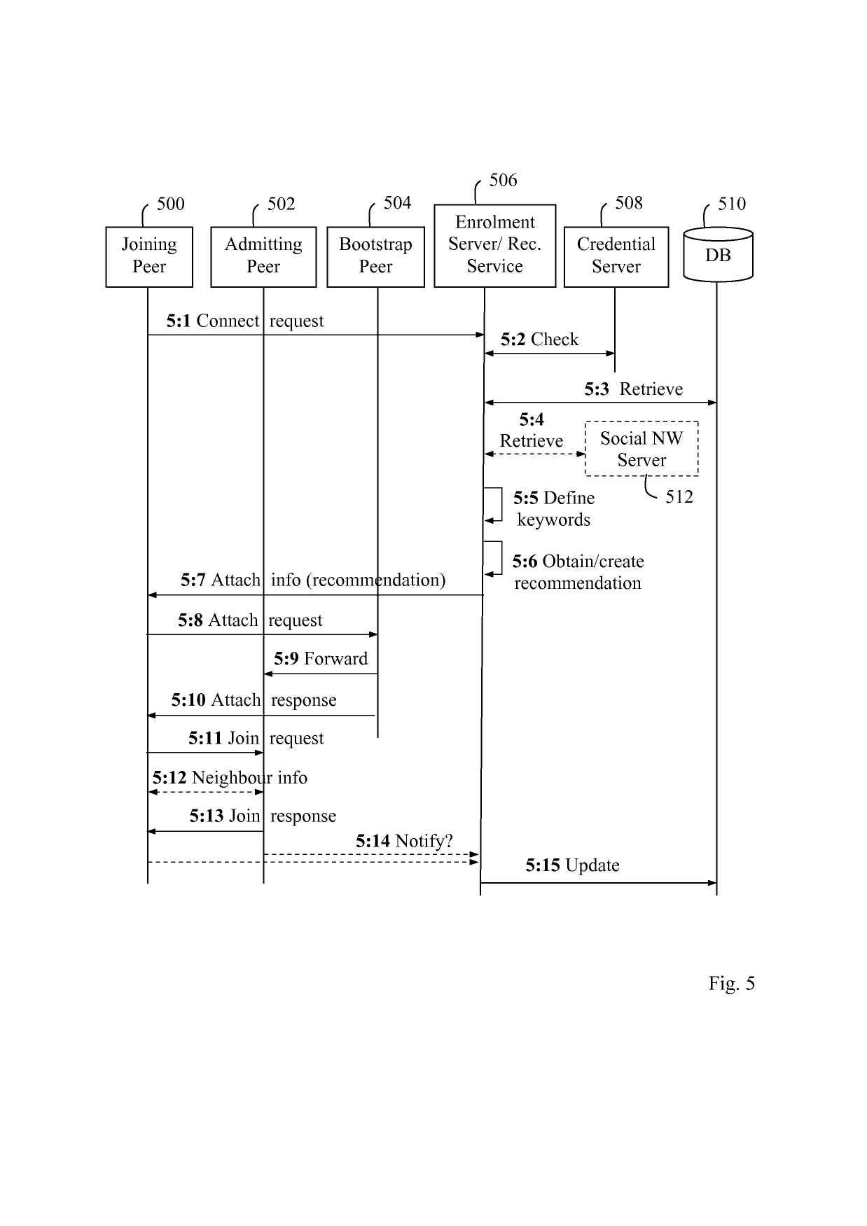

It should be noted that FIG. 4 merely illustrates various functional modules or units in the enrollment server 400 in a logical sense, although the skilled person is free to implement these functions in practice using suitable software and hardware means. Thus, the invention is generally not limited to the shown structures of the enrollment server 400, while its functional modules 400a-d may be configured to operate according to the features described for FIGS. 2 and 3 above and FIG. 5 below, where appropriate.

The functional modules 400a-d described above can be implemented in the enrollment server 400 as program modules of a computer program comprising code means which when run by a processor in the server 400 causes the server 400 to perform the above-described functions and actions. The processor may be a single CPU (Central processing unit), or could comprise two or more processing unit. For example, the processor may include general purpose microprocessors, instruction set processors and/or related chips sets and/or special purpose microprocessors such as ASICs (Application Specific Integrated Circuit). The processor may also comprise board memory for caching purposes.

The computer program may be carried by a computer program product in the server 400 connected to the processor. The computer program product comprises a computer readable medium on which the computer program is stored. for example, the computer program product may be a flash memory, a RAM (Random-access memory), a ROM (Read-Only Memory) or an EEPROM (Electrically Erasable Programmable ROM), and the program modules could in alternative embodiments be distributed on different computer program product in the form of memories within the enrollment server 400.

A practical example procedure of how a joining peer can be enrolled to a P2P network will now be described with reference to the signalling diagram of FIG. 5. This procedure thus involves a joining peer 500, an admitting peer 502, a bootstrap peer 504, an enrollment server 506 in which a recommender service is implemented, a credential server 508, and a database 510 in which a network topology and configurations of the network and participating peers are maintained. In this example, the bootstrap peer 504 is a node different from the enrollment server 506 while these two functions were put together in the same node in the previous example of FIG. 2.

Assuming that the joining peer 500 has already made contact to the P2P network and performed a regular discovery process as described for action 2.1 above, a connect request is transmitted from the joining peer 500 to the enrollment server 506, in a first shown action 5:1, the request preferably also containing on the peer 500 such as its qualifications and/or context The enrollment server 506 checks with the credential server 508 if the joining peer 500 is authorised to join the network, in an action 5:2. Assuming that this is indeed the case, enrollment server 506 continues with retrieving from database 510 a current network topology and information on the other peers in the P2P network such as their roles and qualifications, thus implying the configuration of the network, in a further action 5:3. The enrollment server 506 may also retrieve social network information regarding the joining peer from a specific social network server 512 indicating its proximity to other peers, which is shown by an optional action 5:4.

In a next action 5:5, enrollment server 506 also defines one or more recommended index keywords to be assigned to the joining peer 500, thus indicating available resources and/or other characteristics of the peer 500 which may be used in service requests or queries to the P2P network from outside parties. The enrollment server 506 then creates, i.e. obtains, an enrollment recommendation for the joining peer 500, in a further action 5:6, on the basis of the information retrieved in action 5:4 and the information on peer 500 received therefrom in action 5:1. The enrollment recommendation indicates the admitting peer 502 to which the joining peer 500 shall be connected in the P2P network, and further indicates which role the joining peer 500 shall have in the P2P network involving one or more processing and/or storing tasks. The enrollment recommendation further indicates the bootstrap peer 504 and the index keywords defined in action 5:5.

In a next action 5:7, enrollment server 506 sends attach information to the joining peer 500 indicating a configuration according to the enrollment recommendation, i.e. where/how peer 500 shall connect to the P2P network, in response to the connect request of action 5:1. Accordingly, the attach information identifies in this example the bootstrap peer 504 which has been assigned to handle an attach procedure for the joining peer 500 when connecting to the admitting peer 502, as follows. The attach information may also identify the admitting peer 502 to which the joining peer 500 shall be connected in the new network topology.

In keeping with the received attach information, the joining peer 500 now sends an attach request to the bootstrap peer 504, in a following action 5:8. The bootstrap peer 504 then forwards the attach request to the admitting peer 502, in a next action 5:9, and also sends an attach response to the joining peer 500, in a further action 5:10. If not already identified in the attach information of action 5:7, the admitting peer is identified in the attach response. Thereby, the joining peer 500 is able to connect to the admitting peer 502 as of the recommended topology position and accordingly sends a join request thereto in an action 5:11.

In the connect procedure, the joining peer 500 and the admitting peer 502 may exchange information on their respective neighbors in the network, in a further action 5:12. The connect procedure is completed by the admitting peer 502 sending a join response to the joining peer 500, in another action 5:13. The joining peer 500 or the admitting peer 502 may also notify the enrollment server 506 that connection of the joining peer 500 to the P2P network has been completed, as indicated by dashed arrows in another action 5:14, finally, the enrollment server 506 updates the network topology and information on participating peers maintained in the database 510 with the joining peer 500 having connected to the P2P network, in another action 5:15.

At some point during the lifetime of the P2P network, the enrollment server 506 may receive a leave request from any peer in the network, indicating that this peer is leaving the P2P network, not shown in this figure. The enrollment server 506 will then remove the leaving peer and update the stored topology of the P2P network accordingly.

By using this solution e.g. according to any of the embodiments described above, the enrollment of new peers to a P2P network can be made more efficient or even optimal since at least the network topology and preferably also peer qualifications and current configurations are taken into consideration when defining a fitting network position and role for each new peer. The enrollment process will also impact the ongoing performance of the network as lithe as possible. For example, any other existing procedures and mechanisms for operating a regular P2P network can basically be used without being impacted by the inventive enrollment process.

While the invention has been described with reference to specific exemplary embodiments, the description is generally only intended to illustrate the inventive concept and should not be taken as limiting the scope of the invention. For example, the terms “peer”, “P2P network”, “enrollment server'”, “admitting peer”, “bootstrap peer”, “network topology” and “index keywords” have been used throughout this description, although any other corresponding functions, parameters, nodes and/or unit could also be used having the functionalities and characteristics described here. The invention is defined by the appended claims.

1. A method of enrolling a joining peer (202) to a P2P (peer-to-peer) network (200), the method comprising the following actions executed by an enrollment server (204) associated to the P2P network:
receiving (300) a connect request sent from the joining peer,
obtaining (308) an enrollment recommendation for the joining peer at least based on a stored current topology of the P2P network,
sending (310) attach information to the joining peer according to the enrollment recommendation in response to the connect request, the attach information indicating where the joining peer shall connect to the P2P network, and
updating (316) the stored topology of the P2P network when the joining peer has connected to the P2P network.

2. A method according to claim 1, wherein the enrollment recommendation is further based on qualifications of the joining peer including at least one of current context, capabilities and current status of the joining peer.

3. A method according to claim 1 or 2, wherein the enrollment recommendation is further based on at least one of current roles and/or qualifications of other peers in the P2P network, load balancing, connection cost, latency, enrollment history and social network information regarding the joining peer.

4. A method according to any of claims 1-3, wherein the enrollment recommendation indicates one or more admitting peers to which the joining peer shall be connected in the P2P network.

5. A method according to claim 4, wherein the attach information indicates a bootstrap peer in the P2P network which handles an attach procedure for the joining peer when connecting to the admitting peer(s) by relaying attach messages.

6. A method according to any of claims 1-5, wherein the enrollment recommendation indicates a role the joining peer shall have in the P2P network, said role involving one or more processing and/or storing tasks.

7. A method according to claim 6, wherein the enrollment server further sends configuration information to the joining peer indicating said role.

8. A method according to any of claims 1-7, wherein the enrollment recommendation indicates one or more index keywords to be assigned to the joining peer for use in service requests or queries to the P2P network from outside parties.

9. A method according to any of claims 1-8, wherein the enrollment server receives a leave request from a peer in the P2P network, indicating that this peer is leaving the P2P network, and updates the stored topology of the P2P network accordingly.

10. An arrangement in an enrollment server (400) configured to enroll a joining peer (402) to a P2P network, comprising:
a communication module (400a) adapted to receive a connect request sent from the joining peer,
an obtaining module (400b) adapted to obtain an enrollment recommendation for the joining peer at leastbased on a stored current topology (404) of the P2P network, and
an updating module (400c) adapted to update the stored topology of the P2P network when the joining peer has connected to the P2P network,
wherein the communication module (400a) is further adapted to send attach information to the joining peer according to the enrollment recommendation in response to the connect request, the attach information indicating how the joining peer shall connect to the P2P network.

11. An arrangement according to claim 10, further comprising a recommender service (400d) adapted to create said enrollment recommendation.

12. An arrangement according to claim 10 enroll, wherein the enrollment recommendation is further based on qualifications of the joining peer including at least one of current context, capabilities and current status of the joining peer.

13. An arrangement according to any of claims 10-12, wherein the enrollment recommendation is further based on at least one of current roles and/or qualifications of other peers in the P2P network, load balancing, connection costs, latency, enrollment history and social network information regarding the joining peer.

14. An arrangement according to any of claims 10-13, wherein the enrollment recommendation indicates one or more admitting peers to which the joining peer shall be connected in the P2P network.

15. An arrangement according to claim 14, wherein the attach information indicates a bootstrap peer in the P2P network which handles an attach procedure for the joining peer when connecting to the admitting peer(s) by relaying attach messages.

16. An arrangement according to any of claims 10-15, wherein the enrollment recommendation indicates a role the joining peer shall have in the P2P network, said role involving one or more processing and/or storing tasks.

17. An arrangement according to claim 16, wherein the communication module (400a) is further adapted to send configuration information to the joining peer indicating said role.

18. An arrangement according to any of claims 10-17, wherein the enrollment recommendation indicates one or more index keywords to be assigned to the joining peer for use in service requests or queries to the P2P network from outside parties.

19. An arrangement according to any of claims 1-8, wherein the enrollment server receives a leave request from a peer in the P2P network, indicating that this peer is leaving the P2P network, and updates the stored topology of the P2P network accordingly.
